(19) United States
(12) Patent Application Publication
(10) Pub. No.: US 2008/0217927 A1
(43) Pub. Date: Sep. 11, 2008

(54) Cable systems having at least one section formed of an active material

(75) Inventors: Alan L. Browne, Grosse Pointe, MI (US); Nancy L. Johnson, Northville, MI (US); Kevin B. Rober, Washington, MI (US); James Y. Khoury, Macomb, MI (US)

Correspondence Address: GENERAL MOTORS CORPORATION;LEGAL STAFF, MAIL CODE 482-C23-B21, P O BOX 300, DETROIT, MI, 48265-3000, US

(73) Assignee: GM Global Technology Operations, Inc., Detroit, MI (US)

(21) Appl. No.: 11/682,898

(22) Filed: Mar. 7, 2007

(51) Int. Cl. E05C 3/12

(52) U.S. Cl. 292/28

(57) ABSTRACT

A cable system, a latch assembly employing the cable system and processes thereof include a cable comprising at least one section formed of an active material having one end fixedly attached to a connector, wherein the connector is disposed between a first stop and a second stop, the first and second stops fixedly attached to a stationary support and having an aperture for slidably receiving the cable; and an activation device in operative communication with the active material, the activation device being operable to selectively provide an activation signal to the active material and effectuate a change in a length of the cable section formed or a flexural modulus property of the active material. Suitable active materials include shape memory alloys and electroactive polymers.

### BACKGROUND

This disclosure generally relates to cable systems for performing such functions as hood release, parking brake release/engagement, and fuel filler door opening and more particularly, to hood release, parking brake release/engagement, and fuel filler door opening cable systems using at least in part an active material.

Current parking brake systems for vehicles typically include a hand lever and cable operated system that are cooperatively used to manually apply and/or release the parking brake. A hood release and cable operated system are similarly used to release a hood or cowl. Other cable based systems in vehicles are utilized to facilitate access to the fuel storage tanks. Current prior art systems are relatively simple mechanical devices, wherein cable operation generally requires an action on the part of the vehicle operator, e.g., pulling of a handle/lever. The cables that are employed for these types of systems are typically formed from steel of a fixed length and are coupled to a mechanism that causes the brakes to become engaged, causes the hood and/or cowl to be released from an underlying structure, and the like.

These prior art systems require manual activation. It would be desirable to have systems that can be automatically engaged or disengaged for different applications. For example, it may be desirable in some applications to have the cable system automatically release or engage a latch, for example, based on sensory inputs or button activation. Current systems do not provide this capability.

In view of the foregoing, there is a continual need for improved hood release mechanisms, parking brake cable systems, fuel door release systems, and the like.

### BRIEF SUMMARY

Disclosed herein are cable systems, latch assemblies that employ the cable systems, and processes for actively engaging and disengaging a latch assembly.

In one embodiment, the cable system comprises a cable comprising at least one section formed of active material such as a shape memory alloy (SMA) or alternatively of an electroactive polymer (EAP) having one end fixedly attached to a connector, wherein the connector is disposed between a first stop and a second stop, the first and second stops fixedly attached to a stationary support and having an aperture for slidably receiving the cable; and an activation device in operative communication with the shape memory alloy or EAP, the activation device being operable to selectively provide an activation signal to the shape memory alloy or EAP and effectuate a change in a length of the cable section formed of the shape memory alloy (or EAP) or a flexural modulus property.

In another embodiment, an active latch assembly for effecting engagement or disengagement, comprises an end user mechanism; a cable having one end attached to the end user mechanism and another end attached to a latch assembly, the cable configured such that activation of the end user mechanism engages or disengages the latch assembly, wherein the cable comprises at least one section formed of active material, e.g., a shape memory alloy or an EAP, having one end fixedly attached to a connector, wherein the connector is disposed between a first stop and a second stop, the first and second stops fixedly attached to a stationary support and having an aperture for slidably receiving the cable; an activation device in operative communication with the shape memory alloy or EAP, the activation device being operable to selectively provide an activation signal to the shape memory alloy or EAP and effectuate a change in a length of the cable section formed of the shape memory alloy (or EAP) or a flexural modulus property; and the latch assembly, wherein manual operation of the end user interface mechanism and/or activation of the shape memory alloy (or EAP) cable section engages and disengages the latch assembly.

A process for actively engaging and disengaging a latch assembly comprises activating a an active material such as a shape memory alloy or EAP section of a cable and decreasing a length dimension of the cable, wherein the shape memory alloy (or EAP) section has one end fixedly attached to a connector and another end attached to a lever in operative communication with a spring loaded gate having a u-shaped channel configured to engage or disengage a strike pin, wherein the connector is disposed between a first stop and a second stop, the first and second stops fixedly attached to a stationary support and having an aperture for slidably receiving the cable; moving the lever as a function of the decrease in the length dimension; and releasing the gate from the lever so as to unload the spring loaded gate and engage or disengage the gate with the strike pin.

In yet another embodiment, a latch system comprises a rotary latch assembly configured to rotate about a pivot point and engage a striker pin upon activation of an end user mechanism; a first cable comprising at least one section formed of an active material having one end fixedly attached to a stationary attachment plate and an other end fixedly attached to the rotary latch assembly; a second cable fixedly attached to the rotary latch assembly at one end and at an other end to an end user mechanism; wherein the second cable is slidably disposed with the attachment plate and wherein the first and second cables are fixedly attached at a location of the latch assembly such that activation of the end user mechanism causes the first cable to slacken and the second cable to effect rotation of the latch assembly about the pivot point to an open position; and a bias spring fixedly attached to the latch assembly at a location configured to return the rotary latch to a closed position.

The above described and other features are exemplified by the following detailed description.

### DETAILED DESCRIPTION

A cable system for a vehicle generally includes at least one cable section formed of an active material such as a shape memory alloy (SMA) or electroactive polymer (EAP). By forming a section of the cable with the active material, a simple push button, toggle switch, or the like can be used to trigger activation of the active material so as to selectively change the length dimension and/or modulus properties and cause application of the brakes, release of the hood, fuel door release, and the like. As such, the need for applying a force to effect braking and/or hood release is eliminated as may be desired for different applications. Advantageously, the cable system can still be manually operated to effect release or engagement.

Shape memory alloys are alloy compositions with at least two different temperature-dependent phases or polarity. The most commonly utilized of these phases are the so-called martensite and austenite phases. In the following discussion, the martensite phase generally refers to the more deformable, lower temperature phase whereas the austenite phase generally refers to the more rigid, higher temperature phase. When the shape memory alloy is in the martensite phase and is heated, it begins to change into the austenite phase. The temperature at which this phenomenon starts is often referred to as austenite start temperature (Aₛ). The temperature at which this phenomenon is complete is often called the austenite finish temperature (A_{f}). When the shape memory alloy is in the austenite phase and is cooled, it begins to change into the martensite phase, and the temperature at which this phenomenon starts is often referred to as the martensite start temperature (Mₛ). The temperature at which austenite finishes transforming to martensite is often called the martensite finish temperature (M_{f}). The range between Aₛ and A_{f} is often referred to as the martensite-to-austenite transformation temperature range while that between Mₛ and M_{f} is often called the austenite-to-martensite transformation temperature range. It should be noted that the above-mentioned transition temperatures are functions of the stress experienced by the SMA sample. Generally, these temperatures increase with increasing stress. In view of the foregoing properties, deformation of the shape memory alloy is preferably at or below the austenite start temperature (at or below Aₛ). Subsequent heating above the austenite start temperature causes the deformed shape memory material sample to begin to revert back to its original (non-stressed) permanent shape until completion at the austenite finish temperature. Thus, a suitable activation input or signal for use with shape memory alloys is a thermal activation signal having a magnitude that is sufficient to cause transformations between the martensite and austenite phases.

The temperature at which the shape memory alloy remembers its high temperature form (i.e., its original, non-stressed shape) when heated can be adjusted by slight changes in the composition of the alloy and through thermo-mechanical processing. In nickel-titanium shape memory alloys, for example, it can be changed from above about 100° C. to below about −100° C. The shape recovery process can occur over a range of just a few degrees or exhibit a more gradual recovery over a wider temperature range. The start or finish of the transformation can be controlled to within several degrees depending on the desired application and alloy composition. The mechanical properties of the shape memory alloy vary greatly over the temperature range spanning their transformation, typically providing shape memory effect and superelastic effect. For example, in the martensite phase a lower elastic modulus than in the austenite phase is observed. Shape memory alloys in the martensite phase can undergo large deformations by realigning the crystal structure arrangement with the applied stress. The material will retain this shape after the stress is removed. In other words, stress induced phase changes in SMA are two-way by nature, application of sufficient stress when an SMA is in its austenitic phase will cause it to change to its lower modulus Martensitic phase. Removal of the applied stress will cause the SMA to switch back to its Austenitic phase, and in so doing, recovering its starting shape and higher modulus.

Suitable activation signals include conduction of heat from a support surface to which shape memory alloy cable section is attached, resistance heating of the shape memory alloy cable section, general increases in temperature of the cable assembly and its environment (i.e., convection), combinations comprising at least one of the foregoing, or the like.

Exemplary shape memory alloy materials include nickel-titanium based alloys, indium-titanium based alloys, nickel-aluminum based alloys, nickel-gallium based alloys, copper based alloys (e.g., copper-zinc alloys, copper-aluminum alloys, copper-gold, and copper-tin alloys), gold-cadmium based alloys, silver-cadmium based alloys, indium-cadmium based alloys, manganese-copper based alloys, iron-platinum based alloys, iron-palladium based alloys, and so forth. The alloys can be binary, ternary, or any higher order so long as the alloy composition exhibits a shape memory effect, e.g., change in shape, orientation, yield strength, flexural modulus, damping capacity, superelasticity, and/or similar properties. Selection of a suitable shape memory alloy composition depends, in part, on the temperature range of the intended application.

The recovery to the austenite phase at a higher temperature is accompanied by very large (compared to that needed to deform the material) stresses which can be as high as the inherent yield strength of the austenite material, sometimes up to three or more times that of the deformed martensite phase. For applications that require a large number of operating cycles, a strain of less than or equal to 4% or so of the deformed length of wire used can be obtained. In experiments performed with shape memory alloy wires of 0.5 millimeter (mm) diameter, the maximum strain in the order of 4% was obtained. This percentage can increase up to 8% for applications with a low number of cycles.

Electroactive polymers generally include a laminate of a pair of electrodes with an intermediate layer of low elastic modulus dielectric material. Applying a potential between the electrodes squeezes the intermediate layer causing it to expand in plane. They exhibit a response proportional to the applied field and can be actuated at high frequencies.

Electroactive polymers include those polymeric materials that exhibit piezoelectric, pyroelectric, or electrostrictive properties in response to electrical or mechanical fields. An example of an electrostrictive-grafted elastomer with a piezoelectric poly(vinylidene fluoride-trifluoro-ethylene) copolymer. This combination has the ability to produce a varied amount of ferroelectric-electrostrictive molecular composite systems.

Materials suitable for use as an electroactive polymer may include any substantially insulating polymer and/or rubber that deforms in response to an electrostatic force or whose deformation results in a change in electric field. Exemplary materials suitable for use as a pre-strained polymer include silicone elastomers, acrylic elastomers, polyurethanes, thermoplastic elastomers, copolymers comprising PVDF, pressure-sensitive adhesives, fluoroelastomers, polymers comprising silicone and acrylic moieties (e.g., copolymers comprising silicone and acrylic moieties, polymer blends comprising a silicone elastomer and an acrylic elastomer, and so forth).

Materials used as an electroactive polymer can be selected based on material propert(ies) such as a high electrical breakdown strength, a low modulus of elasticity (e.g., for large or small deformations), a high dielectric constant, and so forth. In one embodiment, the polymer can be selected such that is has an elastic modulus of less than or equal to about 100 MPa. In another embodiment, the polymer can be selected such that is has a maximum actuation pressure of about 0.05 megaPascals (MPa) and about 10 MPa, or, more specifically, about 0.3 MPa to about 3 MPa. In another embodiment, the polymer can be selected such that is has a dielectric constant of about 2 and about 20, or, more specifically, about 2.5 and about 12. The present disclosure is not intended to be limited to these ranges. Ideally, materials with a higher dielectric constant than the ranges given above would be desirable if the materials had both a high dielectric constant and a high dielectric strength.

As electroactive polymers may deflect at high strains, electrodes attached to the polymers should also deflect without compromising mechanical or electrical performance. Generally, electrodes suitable for use can be of any shape and material provided that they are able to supply a suitable voltage to, or receive a suitable voltage from, an electroactive polymer. The voltage can be either constant or varying over time. In one embodiment, the electrodes adhere to a surface of the polymer. Electrodes adhering to the polymer can be compliant and conform to the changing shape of the polymer. The electrodes can be only applied to a portion of an electroactive polymer and define an active area according to their geometry. Various types of electrodes include structured electrodes comprising metal traces and charge distribution layers, textured electrodes comprising varying out of plane dimensions, conductive greases (such as carbon greases and silver greases), colloidal suspensions, high aspect ratio conductive materials (such as carbon fibrils and carbon nanotubes, and mixtures of ionically conductive materials), as well as combinations comprising at least one of the foregoing.

Exemplary electrode materials can include graphite, carbon black, colloidal suspensions, metals (including silver and gold), filled gels and polymers (e.g., silver filled and carbon filled gels and polymers), and ionically or electronically conductive polymers, as well as combinations comprising at least one of the foregoing. It is understood that certain electrode materials may work well with particular polymers and may not work as well for others. By way of example, carbon fibrils work well with acrylic elastomer polymers while not as well with silicone polymers.

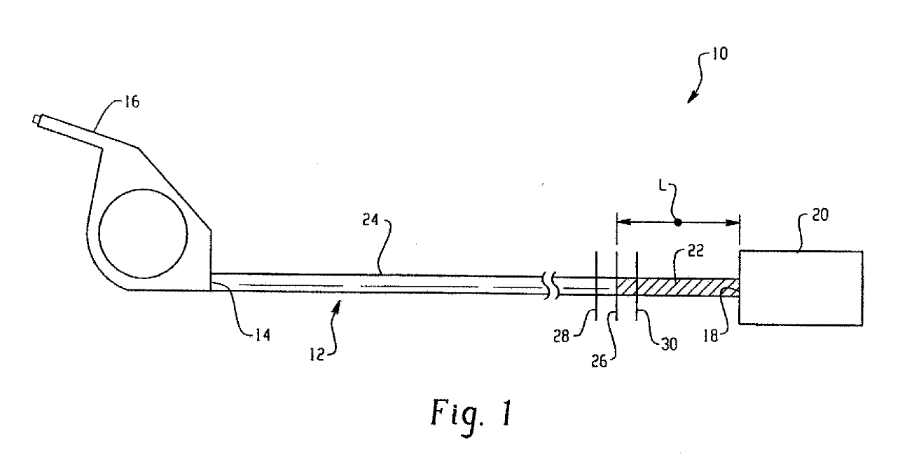

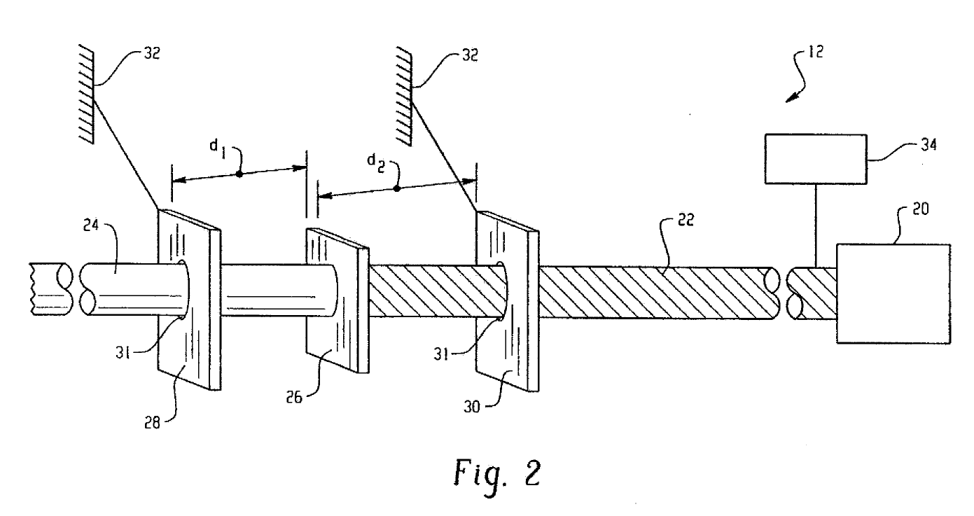

Referring now to FIGS. 1 and 2, there is shown a cable system generally designated by reference numeral 10. The illustrated cable system includes a cable 12 having one end 14 coupled to an end user interface mechanism 16 and the other end 18 coupled to a brake or latch system 20.

It is to be understood that the cable system 10 has been simplified to illustrate only those components that are relevant to an understanding of the present disclosure. Those of ordinary skill in the art will recognize that other components such as brackets and the like may be employed to produce a cable system suitable for use in specific application, e.g., parking brake, hood release, fuel door releases, and like applications. However, because such components are well known in the art, and because they do not further aid in the understanding of the present disclosure, a discussion of such components is not provided.

Likewise, although a parking brake button actuated lever is depicted, it should be noted that the particular end user interface mechanism is not intended to be limited. For example, the end user interface mechanism can be a fulcrum lever such as those currently used for hood brake releases; a push and/or pull button; a crank lever; and the like.

As previously discussed, at least a section 22 of the cable 12 having a defined length L is formed of the active material, e.g., an SMA or an EAP. The remaining section 24 is formed from a conventional material commonly used for the intended application such as a flexible steel cable. The sections of cable, e.g., 22, 24, are connected to one another via a connector 26. The connector 26 is formed of a material and is configured to electrically isolate the shape memory alloy or EAP cable section from cable section 24. The connector 26 is positioned between stops 28, 30, which are fixedly attached to a rigid and stationary structural member 32, the shapes of which are not intended to be limited to any particular shapes or configurations. Stops 28, 30 include an aperture 31 dimensioned for slidably receiving the cable 12 during movement thereof whereas the connector 26 is dimensioned to be larger than the aperture 31. In this manner, limited movement of the cable 12 results because of contact of the connector 26 with either stop 28 or 30 depending on the direction and extent of cable movement. For example, when the cable 12 is engaged by an end user mechanism 16, e.g., pulling upwards on a parking brake handle or lifting a hood release lever, the connector 26 would travel as a function of the cable movement from its position as shown to a maximum distance (d₁) as defined by stop 28. Depending on the applied tension to the cable 12, in some embodiments, the shape memory alloy cable section 22 may pseudoplastically deform in its room temperature martensite state. As another example, in the event the shape memory alloy cable section 22 is activated, a decrease in a length dimension of the cable section 22 can occur such that connector 26 would travel up to a maximum distance (d₂) to stop 30 from the original position as shown. It should be apparent that the maximum distance would be represented by the total distance between stops 28, 30, i.e., (d₁)+(d₂). In still another example,

It should be apparent to those skilled in the art that operation of EAP would differ from SMAs in that power on (i.e. applying a voltage across an EAP) in general would effect an increase in the length of the cable or strip. Thus, to cause shortening of the cable and release of a latch one would turn off the power.

The active material cable section is in operative communication with actuator 34 for activating the active material. The actuator 34 can be disposed in any location as may be desired for the intended application. For example, the actuator could be disposed within a contained hood for a trunk so as to permit trunk release and egress in the event an occupant is accidentally locked within the trunk or the actuator may be integrated with a computer system to effect release as may be desired for different situations, e.g., shape memory alloy, with electrical connections provided at each end of the shape memory alloy cable. However, it should be noted that other means for activating the active material could be used as would be apparent to those of ordinary skill in the art.

As an example of a suitable actuator, the actuator can be a power supply that is configured to resistively heat the shape memory alloy or supply current to the electroactive polymer. For example, upon resistive heating of the shape memory alloy cable section 22 an increase in modulus by a factor of 2.5 to 3.0 and a decrease in length dimension can be observed such that the decrease in length causes a latch to disengage, for example. Discontinuation of the activation signal causes the shape memory alloy cable to cool in so doing lowering their modulus by a factor of 2.5 to 3.0. In this manner, the forces associated with the shape memory alloy cable are decreased, thereby causing the overall cable tension to stretch the shape memory alloy cable (stress induced transformation to a martensite phase) and allow the latch to become re-engaged.

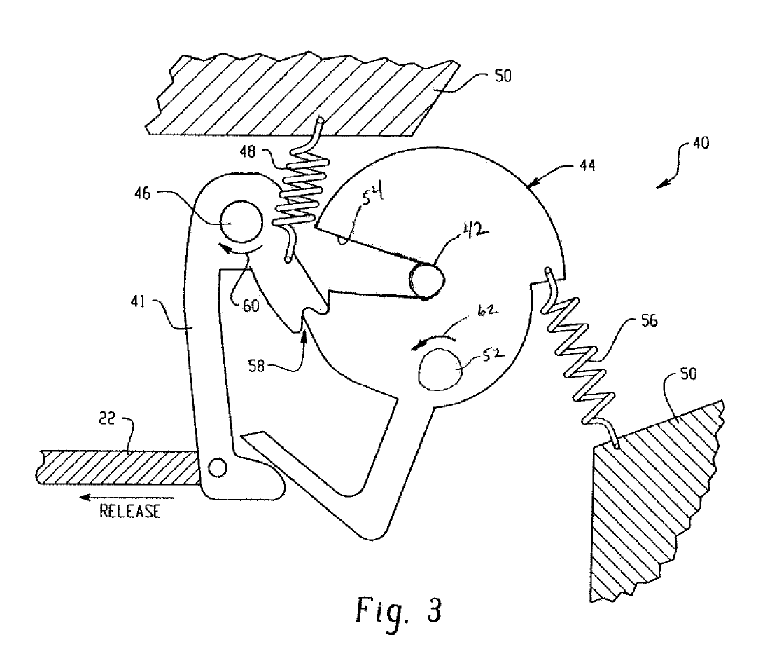

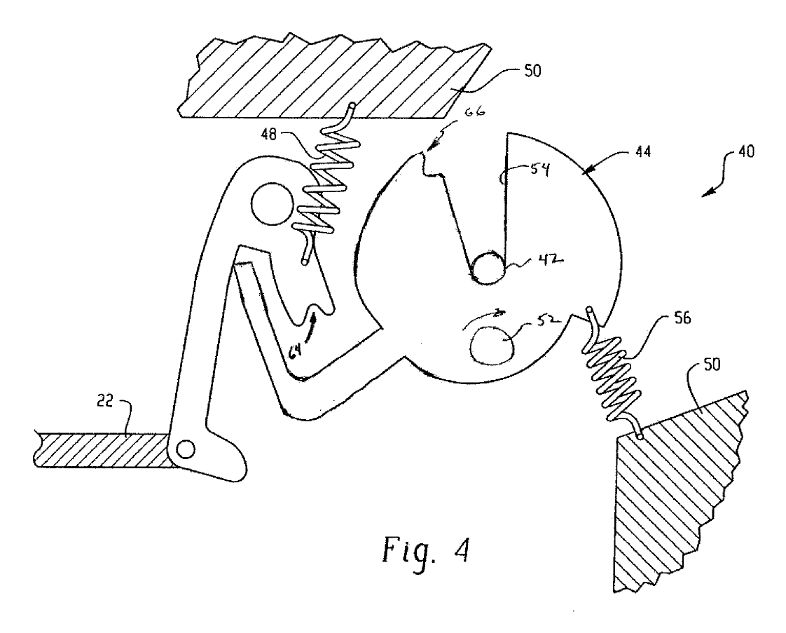

FIGS. 3 and 4 illustrate an exemplary latch assembly 40 coupled to one end of the active material cable section 22. In FIG. 3, the latch assembly is illustrated in an engaged position with a striker pin 42. In FIG. 4, the latch assembly is shown disengaged from the striker pin 42. The exemplary latch assembly 40 could be one component of a hood release, for example. An end user can effect release by end user movement of an interface mechanism 16, e.g., a lever or a switch seated within the vehicle that moves the cable so as to disengage a latch or brake, by a push button that activates the active material so as to cause a length change to the cable, or as previously indicated by use of sensors that automatically activate the active material upon detection of a predetermined condition. Optionally, in the case of electroactive polymers, the sensors or manual activation of then end user mechanism can turn the power off to the EAP, thereby causing a contraction in the length dimension.

In the illustrated latch assembly 40, which is intended to be exemplary and not limiting, a lever 41 is in a cooperative relationship with a gate 44. The active material cable section 22 is attached to one end of the lever 41. In one embodiment, the lever 41 is electrically isolated from the active material cable section 22. The gate 44 is configured to selectively engage and disengage the striker pin 42. The striker pin 42 can be attached to or integral with a component such as a hood or other body so that the hood or body can be selectively secured and released relative to a structure, e.g., vehicle frame. The striker pin 42 can be of any shape or configuration desired for the intended application that permits engagement and disengagement with the gate 44, e.g., pin, hook, u-shaped bracket, and the like.

The lever 41 is rotatably disposed on axle 46 and is in biased communication with spring 48, which has one end attached to the lever 41 and its other end attached to a stationary structure 50. In a similar manner, the gate 44 is rotatably disposed on axle 52 and includes a bias spring 56 attached to the gate 44 at one end and to the stationary structure 50 at another end. The gate 44 includes a striker-engaging portion 54, shown here as a portion of the engageable portion having a u-shaped opening that engages and disengages the striker pin depending on the position of the u-shaped opening relative to the striker pin. The gate 44 and the lever 41 further include portions that define an engageable detent, shown generally at 58. The structure 58 of the engageable detent is not intended to be limited. By way of example, the engageable detent 58 is defined by a recessed portion 64 in the lever 41 and a boss 66 projecting from the gate 44 that is adapted to seat within the recessed portion 64.

During operation, movement of the cable 12 via activation of the shape memory alloy cable section 22 (or deactivation of the EAP) or by manually pulling on the cable 12 causes the lever 41 to rotate in a clockwise direction (arrow 60 in FIG. 3), which also cause counter-rotation of the gate 44 (arrow 62 in FIG. 3). The movement of the lever 41 and the gate 44 in this manner causes the lever 41 and the gate 44 to become disengaged from its detent position. Once the detent is disengaged, the bias spring 56 causes clockwise rotation of the gate 44 to a position that permits the striker pin 42 to be removed from the gate 44.

Engaging the striker pin 42 (while the release 16 is in the engaged position and/or the shape memory alloy cable section is not activated) with the gate 44 would cause the counter-rotation of the gate such that the boss 66 of the gate 44 engages the recessed portion 64 of the lever 41. It should be apparent that the gate could be suitably arranged to permit engagement of the strike pin upon activation of the shape memory alloy cable section and/or upon manual activation of the end user interface mechanism.

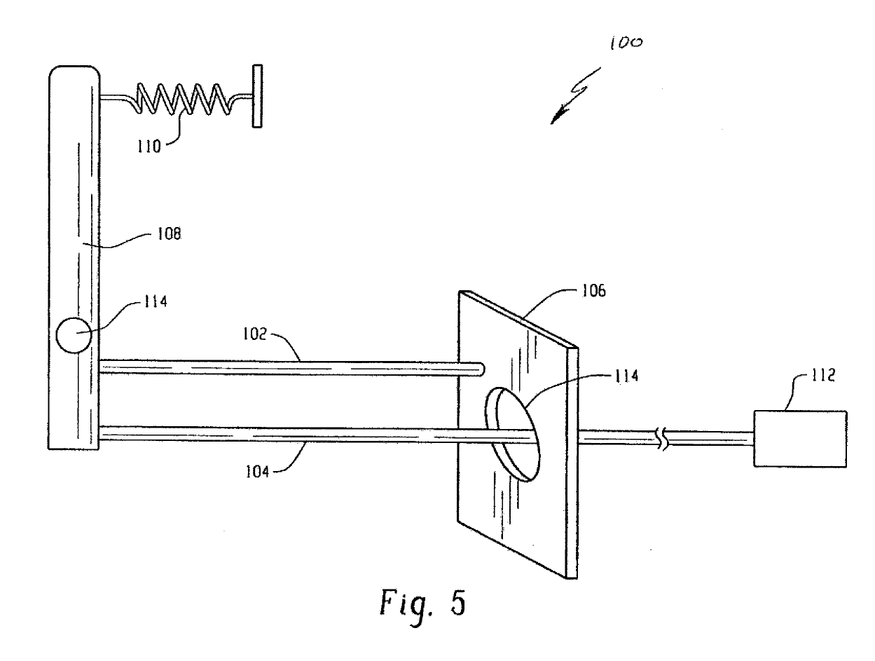

FIG. 5 illustrates an alternative embodiment of a cable system 100 coupled to a rotary latch assembly. In this embodiment, a cable 102 with at least one section of SMA (or EAP) is disposed in parallel or as part of a multi-wire bundle 104 formed of a conventional cable material such as steel. The wire with an SMA (or EAP) section is attached at one end to a rotary latch 108 such as the one described above and at the other to a fixed attachment plate 106. Use of the term “fixed” is intended to infer that the attachment plate 106 is stationary, e.g., may be fixedly attached to a stationary structure within the vehicle. The steel cable 104 is also attached at one end to the rotary latch 108 and at the other end to an end user mechanism 112, e.g., a handle. Cable 104 passes through a through an aperture 114 in the attachment plate 106. Engaging the end user mechanism will rotate the rotary latch about pivot (axle) 114 and also cause a decrease tension within the SMA cable 102, i.e., cause slack. Likewise activating the SMA portion in cable 102 will cause slack in the other cable 104. A bias spring 110 can be used to return the rotary latch 108 to the closed position in so doing eliminating any slack in either or both cables 102, 104, and in so doing will re-stretch the SMA cable section 102.

Ranges disclosed herein are inclusive and combinable (e.g., ranges of “up to about 25 wt %, or, more specifically, about 5 wt % to about 20 wt %”, is inclusive of the endpoints and all intermediate values of the ranges of “about 5 wt % to about 25 wt %,” etc.). “Combination” is inclusive of blends, mixtures, derivatives, alloys, reaction products, and the like. Furthermore, the terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item. The modifier “about” used in connection with a quantity is inclusive of the state value and has the meaning dictated by context, (e.g., includes the degree of error associated with measurement of the particular quantity). The suffix “(s)” as used herein is intended to include both the singular and the plural of the term that it modifies, thereby including one or more of that term (e.g., the colorant(s) includes one or more colorants). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements can be combined in any suitable manner in the various embodiments.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the invention not be limited to the particular embodiment disclosed as the best mode contemplated for carrying out this disclosure.

What is claimed is:

1. A cable system, comprising:
a cable comprising at least one section formed of an active material having one end fixedly attached to a connector, wherein the connector is disposed between a first stop and a second stop, the first and second stops fixedly attached to a stationary support and having
apertures for slidably receiving the cable; and
an activation device in operative communication with the active material, the activation device being operable to selectively provide an activation signal to the active material and effectuate a change in a length or a flexural modulus property of the cable section.

2. The cable system of claim 1, wherein the active material is selected from a group consisting of shape memory alloy, and an electroactive polymer.

3. The cable system of claim 2, wherein the shape memory alloy cable section is electrically isolated at the one end.

4. The cable system of claim 2, wherein the activation signal comprises conduction of heat from a support surface to which shape memory alloy cable section is attached, resistance heating of the shape memory alloy cable section, increases in environmental temperature of the cable system, and combinations comprising at least one of the foregoing.

5. The cable system of claim 1, wherein the cable system is configured for manual activation, active activation, or a combination of manual and active activation, wherein active activation comprises providing the activation signal to the shape memory alloy cable section.

6. The cable system of claim 2, wherein the activation signal comprises an electrical signal applied to the electroactive polymer cable section.

7. An active latch assembly for effecting engagement or disengagement, comprising:
an end user mechanism;
a cable having one end attached to the end user mechanism and another end attached to a latch assembly, the cable configured such that activation of the end user mechanism engages or disengages the latch assembly, wherein the cable comprises at least one section formed of an active material having one end fixedly attached to a connector, wherein the connector is disposed between a first stop and a second stop, the first and second stops fixedly attached to a stationary support and having an aperture for slidably receiving the cable;
an activation device in operative communication with the active material, the activation device being operable to selectively provide an activation signal to the active material and effectuate a change in a length of the cable section formed or a flexural modulus property of the active material; and
the latch assembly, wherein manual operation of the end user interface mechanism and/or activation of the active material cable section engages and disengages the latch assembly.

8. The active latch assembly of claim 7, wherein the active material is selected from a group consisting of shape memory alloy, and an electroactive polymer.

9. The active latch assembly of claim 8, wherein the shape memory alloy cable section is electrically isolated at the one end.

10. The active latch assembly of claim 8, wherein the activation signal comprises conduction of heat from a support surface to which shape memory alloy cable section is attached, resistance heating of the shape memory alloy cable section, increases in environmental temperature of the cable system, and combinations comprising at least one of the foregoing.

11. The active latch assembly of claim 7, wherein the cable system is configured for manually activation, active activation, or a combination of manually and active activation, wherein active activation comprises providing the activation signal to the active material cable section.

12. The active latch assembly of claim 7, wherein the latch assembly comprises a lever in operative communication with the cable and a rotatable gate that is configured to engage and release a striker pin; wherein the lever and the rotatable gate are each in biased communication with a spring such that manual activation of the end user mechanism effects the engagement or the release of the striker pin.

13. The active latch assembly of claim 7, wherein the latch assembly comprises a lever in operative communication with the cable and a rotatable gate that is configured to engage and release a striker pin; wherein the lever and the gate are each in biased communication with a spring such that activation of the active material cable section effects the engagement or the release of the striker pin.

14. The active latch assembly of claim 12, wherein the gate comprises a u-shaped channel portion configured to engage and disengage the striker pin upon rotation thereof.

15. The active latch assembly of claim 12, wherein the gate further comprises a boss in operative communication with a recessed portion of the lever to define an engageable detent position, wherein actuation of the end user mechanism moves the lever from the detent position and causes the gate to rotate as a function of the biased spring to effect release or engagement of the striker pin.

16. A process for actively engaging and disengaging a latch assembly, comprising:
activating an active material section of a cable and decreasing a length dimension of the cable, wherein the active material section has one end fixedly attached to a connector and another end attached to a lever in operative communication with a spring loaded gate having a u-shaped channel configured to engage or disengage a strike pin, wherein the connector is disposed between a first stop and a second stop, the first and second stops fixedly attached to a stationary support and having an aperture for slidably receiving the cable;
moving the lever as a function of the decrease in the length dimension; and
releasing the gate from the lever so as to unload the spring loaded gate and engage or disengage the gate with the strike pin.

17. The process of claim 16, wherein the active material is selected from a group consisting of shape memory alloy, and an electroactive polymer.

18. The process of claim 16, wherein moving the lever comprises releasing a detent formed between the lever and the gate.

19. The process of claim 17, wherein activating the shape memory alloy cable section comprises conduction of heat from a support surface to which shape memory alloy cable section is attached, resistance heating of the shape memory alloy cable section, increases in environmental temperature of the cable system, and combinations comprising at least one of the foregoing.

20. The process of claim 16, wherein the lever is in biased communication with a spring for restoring a detent position between the lever and spring loaded gate when the active material cable section is not activated.

21. The process of claim 16, wherein the cable is first manually activated such that the connector travels between the first and second stop.

22. A latch system, comprising:
a rotary latch assembly configured to rotate about a pivot point and engage a striker pin upon activation of an end user mechanism;
a first cable comprising at least one section formed of an active material having one end fixedly attached to a stationary attachment plate and an other end fixedly attached to the rotary latch assembly;
a second cable fixedly attached to the rotary latch assembly at one end and at an other end to an end user mechanism; wherein the second cable is slidably disposed with the attachment plate and wherein the first and second cables are fixedly attached at a location of the latch assembly such that activation of the end user mechanism causes the first cable to slacken and the second cable to effect rotation of the latch assembly about the pivot point to an open position; and
a bias spring fixedly attached to the latch assembly at a location configured to return the rotary latch to a closed position.

23. The latch system of claim 22, wherein the active material is selected from a group consisting of shape memory alloy, and an electroactive polymer.
